(19) United States
(12) Patent Application Publication
(10) Pub. No.: US 2007/0260550 A1
(43) Pub. Date: Nov. 8, 2007

(54) Digital goods export control

(76) Inventors: Tobid Pieper, Orinda, CA (US); Paul Martinelli, Berkeley, CA (US); Ariane Habets, Pleasant Hill, CA (US); Donald James Turtle, Orinda, CA (US); Andrew T. Akiyoshi, Berkeley, CA (US)

Correspondence Address: FISH & RICHARDSON P.C., PO BOX 1022, MINNEAPOLIS, MN, 55440-1022, US

(21) Appl. No.: 11/409,497

(22) Filed: Apr. 20, 2006

(51) Int. Cl. H04L 9/00

(52) U.S. Cl. 705/59

(57) ABSTRACT

Method and apparatus supporting export control of restricted digital goods. In one implementation a request is received from a user to download a license key, where the license key applies to one or more digital goods. Information about the user is also received. Which of the one or more digital goods is subject to a most restrictive set of export controls is identified. An export control check is performed based on the identified digital good and the information related to the user. If the export control check is passed, then access to the license key is granted to the user. Otherwise, if the export check is failed, access to the license key to the user is denied.

### TECHNICAL FIELD

This invention relates to export control of restricted digital goods.

### BACKGROUND

Digital goods, including software, audio and video files, are subject to export control. Depending on a number of factors, including the nature of the digital good, the content of the digital good, the end user to whom the digital good is being provided and the location of the end user, export controls may prohibit export or may require a license in order to export to the end user. In the United States, whether or not the content of the digital good includes encryption technology is one factor affecting the export controls applicable to the digital good. Examples of licenses that may be required to export a digital good from the United States include: an export license from the Bureau of Industry and Standards (BIS) of the Department of Commerce for goods controlled by the Export Administration Regulations (EAR); an export license from the Directorate of Defense Trade Controls of the Department of State for goods controlled by the International Traffic in Arms Regulations (ITAR); and an export license from the Office of Foreign Assets Control (OFAC) of the Department of the Treasury for goods controlled by the OFAC.

To control access to a digital good to those entitled to the digital good, a license key may be required by the end user to access the digital good. The practice of requiring one or more license keys to enable usage of a digital good is often referred to as Digital Rights Management (DRM). The license key may be delivered electronically, e.g., over a web page, a web service, or by e-mail, whether or not the digital good itself was delivered electronically, and may be provided with the digital good or separately. Export of the license key itself may constitute an export that is subject to the export controls applicable to digital goods, and therefore may be prohibited in some instances, or require a license to export.

### SUMMARY

This invention relates to export control of restricted digital goods. In general, in one aspect, the invention features a computer-implemented method, a computer program product and a system for performing an export control check when a request is received from a user to download a license key. The request received includes information related to the user and the license key applies to one or more digital goods. Which of the one or more digital goods is subject to a most restrictive set of export controls is identified. An export control check is performed based on the identified digital good and the information related to the user. If the export control check is passed, then access to the license key is granted to the user. Otherwise, if the export check is failed, access to the license key to the user is denied.

Implementations of the invention may include one or more of the following features. Receiving a request from a user to download a license key can include: verifying an identity of a user; presenting to the user a list of one or more digital goods licensed to the user; and receiving from the user a selection of a digital good from the list. Identifying which of the one or more digital goods is subject to a most restrictive set of export controls can include: for each of the one or more digital goods, identifying an export control classification number (ECCN) and if the ECCN is one for which a license exception code is required, then identifying a license exception code; and identifying which of the one or more digital goods is subject to the most restrictive set of export controls based on their respective ECCN and, if required, license exception code.

Performing an export control check can include performing one or more checks where the checks performed are adapted to a most restrictive set of export controls of any of the one or more digital goods to which the license key applies. An identity of a user can be verified, including determining at least one or more of the following about the user: an e-mail address, the user's computer's IP address (Internet address), a billing name and address, a shipping name and address, or the user's name and address, Performing an export control check based on the identified digital good and information related to the user can include performing at least one or more of the following checks: comparing the user's e-mail address domain to lists of restricted countries; comparing the user's billing name and address to lists of restricted persons, entities and countries; comparing the user's shipping name and address to lists of restricted persons, entities and countries; or comparing the user's name and address to lists of restricted persons, entities and countries.

The one or more checks performed can be adapted to a most restrictive set of export controls of any of the one or more digital goods to which the license key applies. Identifying which of the one or more digital goods is subject to a most restrictive set of export controls can include: for each of the one or more digital goods, identifying an export control classification number (ECCN) and if the ECCN is one for which a license exception code is required, then identifying a license exception code; and identifying which of the one or more digital goods is subject to the most restrictive set of export controls based on their respective ECCN and, if required, license exception code.

In general, in another aspect, the invention features a computer-implemented method, a computer program product and a system for performing an export control check. A request is received from a user to download a digital good or a license key that applies to a digital good. An export control check is performed based on the digital good and information related to the user, including: determining a country location of the user using a geolocation service; and comparing the country location to a list of restricted countries; and if the export control check is not passed, denying access to the digital good or license key to the user.

In general, in another aspect, the invention features a computer-implemented method, computer program product and a system for performing a preliminary export control check. A licensee list is received from a customer, where each licensee has been licensed a digital good by the customer. Prior to notifying each licensee of the availability of their corresponding licensed digital good or license key for the digital good, a preliminary export control check is performed for each licensee based on their licensed digital good and information related to the licensee. If based on the preliminary export control check, a licensee is found restricted from receiving the licensee's corresponding licensed digital good or license key, then the customer is automatically notified of the restriction and confirmation that the licensee is authorized to receive the digital good is requested. If the customer confirms authorization of the licensee to receive the digital good or license key, then an export control check system is instructed to override a restriction against export of the licensed digital good or license key to the licensee in a future export control check and the licensee is notified of the availability of the licensed digital good or the license key.

Implementations of the invention can include one or more of the following features. If a licensee has been licensed more than one digital good, then performing the preliminary export control check can include: identifying which of the digital goods is subject to a most restrictive set of export controls; and performing the export control check based on the identified digital good and the information related to the user. Identifying which of the digital goods is subject to a most restrictive set of export controls can include: for each of the digital goods, identifying an export control classification number (ECCN) and if the ECCN is one for which a license exception code is required, then identifying a license exception code; and identifying which of the digital goods is subject to the most restrictive set of export controls based on their respective ECCN and, if required, license exception code.

Performing a preliminary export control check can include performing one or more checks where the checks performed are adapted to the most restrictive set of export controls. The licensee list can include at least one or more of the following about the licensee: an e-mail address, a billing name and address, a shipping name and address, or the licensee's name and address. Performing the preliminary export control check for each licensee based on their licensed digital good and information related to the licensee can include performing at least one or more of the following checks: comparing the licensee's e-mail address domain to lists of restricted countries; comparing the licensee's billing name and address to lists of restricted persons, entities and countries; comparing the licensee's shipping name and address to lists of restricted persons, entities and countries; or comparing the licensee's name and address to lists of restricted persons, entities and countries.

If more than one digital good is licensed to the licensee then the one or more checks performed can be adapted to a most restrictive set of export controls of any of the digital goods. Which of the digital goods is subject to a most restrictive set of export controls can be identified, including: for each of the digital goods, identifying an export control classification number (ECCN) and if the ECCN is one for which a license exception code is required, then identifying a license exception code; and identifying which of the digital goods is subject to the most restrictive set of export controls based on their respective ECCN and, if required, license exception code. If the licensee was found restricted based on the licensee's identity, then the export control check system can be disallowed from overriding the restriction against export of the licensed digital good or license key in a future export control check.

Particular implementations of the invention can realize one or more of the following advantages. An exporter of a digital good and/or a license key for a digital good can ensure compliance with export regulations even when exporting just the license key itself. Using geolocation services to determine a country where the recipient of the digital good and license key is located can improve reliability of the export control checks. Providing an export restriction override to digital good exporters can avoid unnecessary embarrassment and inefficiency when providing digital goods and/or license keys to their end user licensees and provide for improved customer relations as between the digital good provider and licensees.

The details of one or more embodiments of the invention are set forth in the accompanying drawings and the description below. Other features, aspects, and advantages of the invention will be apparent from the description and drawings, and from the claims.

### DESCRIPTION OF DRAWINGS

FIG. 1 is a flowchart showing a process for verifying compliance with export controls when exporting a license key.

FIG. 2 is a flowchart showing a process for performing various checks when verifying compliance with export controls.

FIG. 3 is a flowchart showing a process for permitting an override on an export restriction.

Like reference symbols in the various drawings indicate like elements.

### DETAILED DESCRIPTION

A process for verifying compliance with export controls when exporting a digital good or a license key for a digital good is described. A user that has received a digital good, e.g., software, an audio file or a video file, may require a license key to access the digital good. Examples of license keys include activation codes or files including the names of features to be enabled (e.g., if the digital good is software) and/or authorized user names. The license key may be provided to the user electronically, for example, by e-mail, by a link on a web page, or automatically to the user's computer via a web service. The license key may be provided at the same time as providing the digital good itself, but often for enhanced security is provided separately. In some instances, the license key may apply to more than one digital good. If export controls apply to one or more of the digital goods to which the license key applies, then exporting the license key itself may be subject to the same export controls.

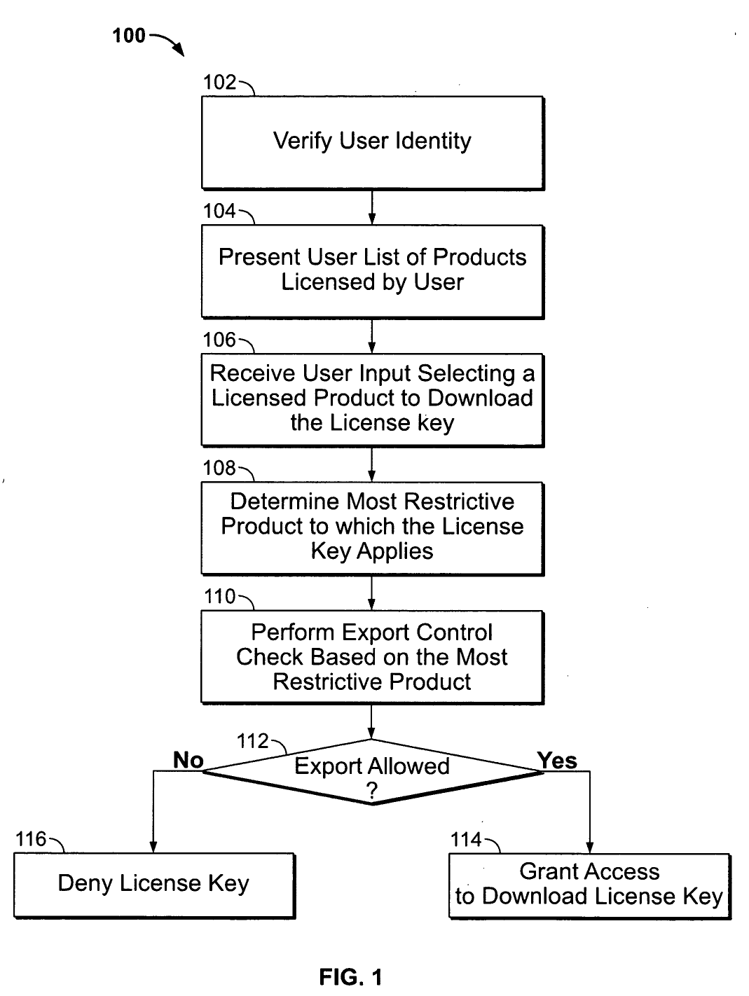

FIG. 1 shows a process 100 for verifying compliance with export controls when exporting a license key. An end user of a licensed digital good (referred to as a “user”), may request a license key in a variety of ways. As one example, the user may click a link in e-mail sent to the user advising of the license key and link to a web page, from which the user can follow prompts to download the license key. In any event, when a user makes a request to download a license key, there is typically (although not necessarily) a verification of the user's identity performed (Step 102). For example, a user may be required to enter a user name and/or user password.

In one implementation, a user is presented with a list of digital goods that are licensed to the user (Step 104). The user can select the digital good from the list for which the user would like to download the corresponding license key (Step 106). In other implementations, the user can be presented with a link the user can click to download directly the license key, the link either being embedded in an e-mail message or on a web page.

A license key can apply to more than one digital good. For example, the license key may be required to access a licensed software program and to access one or more patches or updates to the software. A determination is made as to which of the one or more digital goods is subject to the most restrictive export controls (Step 108). An export control check is performed based on compliance with the most restrictive export controls (Step 110). If the export control check is passed, meaning the license key may be exported to the user (“Yes” branch of decision step 112), then access to the license key is allowed and the user may download the key (Step 114). If the export control check is not passed, meaning the license key may not be exported to the user (“No” branch of decision step 112), then access to the license key is denied (Step 116).

In one implementation, the digital good to which the license key applies that has the most restrictive export controls is determined as follows. An export control classification number (ECCN) is identified. An ECCN is assigned to the digital good by the digital good provider and can be determined by following the Export Administration Regulations. The ECCN applicable to a digital good can be assigned by a comparison of the content of the digital good and the criteria of the different ECCNs as provided in the Export Administration Regulations.

By way of example, if the digital good is software that contains no encryption, then the digital good is usually classified under ECCN EAR99, no BIS review is required and exports are permitted to all countries except terrorist and embargoed countries. However, if the digital good is software that contains encryption, then it is usually classified with ECCN 5D992, and BIS notice and/or review may be required, and exports are permitted to all countries except terrorist and embargoed countries.

The determination of which digital good is subject to the most restrictive export controls can be determined once the ECCN is known based on the export controls applied to digital goods with those respective classifications. For example, if a license key applied to two digital goods and one had ECCN EAR99 and the other had ECCN 5D992, the digital good classified as ECCN 5D992 would be identified as the digital good to which the most restrictive export controls applied. The above example is merely illustrative, and is not necessarily accurate in terms of ECCN classifications, as regulations governing classification do change from time to time.

Additionally, the US Government regulations for license exception ENC differentiate between “restricted” and “unrestricted” digital goods. Unrestricted digital goods can be exported to a larger group of countries and entities than restricted digital goods. Thus, if the digital good has an ECCN classification that can have varying export controls depending on whether the digital good is restricted or unrestricted, then a “license exception code”, which is a code identifying whether the digital good is restricted or unrestricted, is also required to make a determination as to which digital good is subject to the most restrictive controls.

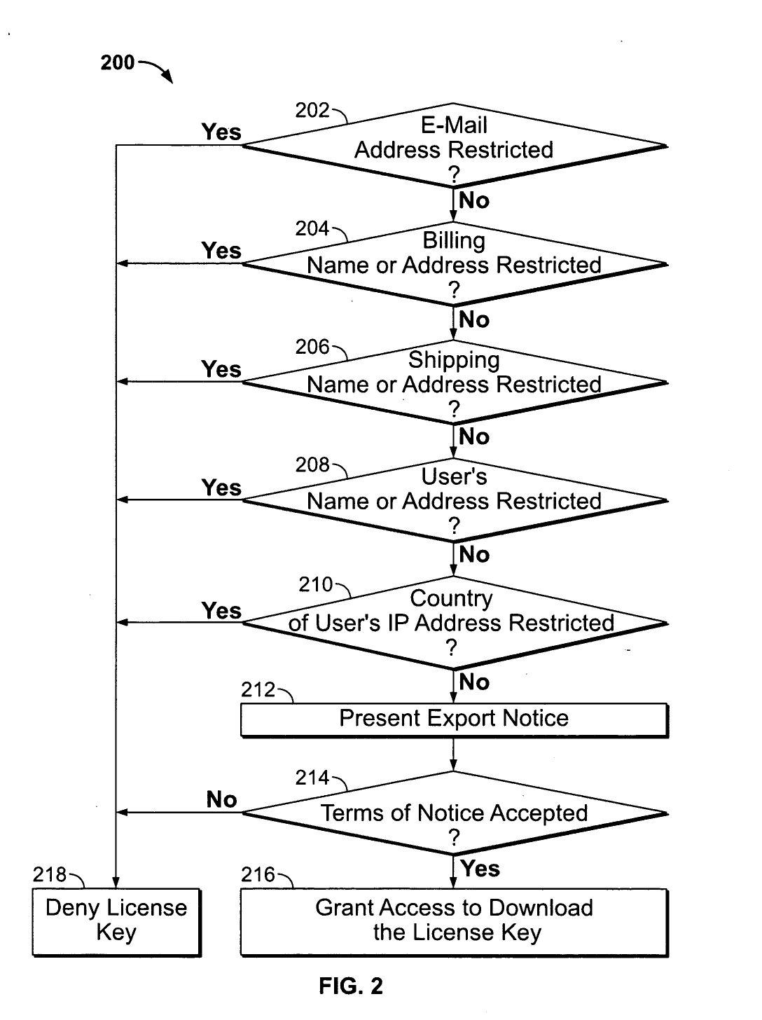

Once the digital good to which the most restrictive export controls are applied has been identified, then the export control checks performed can be adapted to ensure compliance with the most restrictive export controls. FIG. 2 is a flowchart showing one implementation of a process 200 for performing an export control check. Various information related to the user is checked against one or more lists of restricted persons, entities and/or countries.

In this implementation, the domain of a user's e-mail address is used to determine the originating country of the e-mail address, and thereby the location of the user. This technique of determining a location of a user is not failsafe, but can provide a generally reliable determination of the user's country location. The determined country is compared against lists of restricted countries (Step 202). For example, an address ending in “.ca” typically is a Canadian e-mail address, and the country (i.e., Canada) can be checked against lists of embargoed and terrorist-supporting countries. If the e-mail address fails the check, i.e., is found restricted for being an e-mail address originating from a restricted country (“Yes” branch of decision step 202), then the license key is denied (Step 218). If the e-mail address passes the check (“No” branch of decision step 202), then the process 200 moves to a next check.

In this implementation, the billing name and address of the user requesting the license key is checked against lists of restricted countries, companies and persons to determine whether export of the license key is restricted (Step 204). In the case of an individual, the billing name and address may be either the individual's personal name and address, or if the individual is licensing the software as the employee of a company, the billing name and address may belong to the employer. The country included in the billing address is checked against lists of embargoed and terrorist-supporting countries. The billing name is checked against one or more government lists of restricted entities, including companies and individuals and in some instances against lists of restricted governments. If the country included in the billing address fails the check and/or the billing name fails the check, (“Yes” branch of decision step 204), then the license key is denied (Step 218). If the billing name and address pass the check (“No” branch of decision step 204), then the process 200 moves to a next check.

The shipping name and address of the user requesting the license key is checked against lists of restricted countries, companies and persons, and in some instances against lists of restricted governments, to determine whether export of the license key is restricted (Step 206). In the case of an individual, the shipping name and address may be either the individual's personal name and address, or if the individual is licensing the software as the employee of a company, the shipping name and/or address may belong to the employer. The country included in the shipping address is checked against lists of embargoed and terrorist-supporting countries. The shipping name is checked against one or more government lists of restricted entities, including companies and individuals. If the country included in the shipping address fails the check and/or the shipping name fails the check, (“Yes” branch of decision step 206), then the license key is denied (Step 218). If the shipping name and address pass the check (“No” branch of decision step 206), then the process 200 moves to a next check.

The name and address of the user requesting the license key is checked against lists of restricted countries, companies and persons, and in some instances against lists of restricted governments, to determine whether export of the license key is restricted (Step 208). In the case of an individual, the address may be either the individual's personal address, or if the individual is licensing the software as the employee of a company, the user's personal address may not be provided, and the address of the employer can be checked. The country included in the user's address is checked against lists of embargoed and terrorist-supporting countries. The user's name is checked against one or more government lists of restricted entities, including companies and individuals. If the country included in the user's address fails the check and/or the user's name fails the check, (“Yes” branch of decision step 208), then the license key is denied (Step 218). If the user's name and address pass the check (“No” branch of decision step 208), then the process 200 moves to a next check.

The location of the user is significant, as there are lists of restricted countries that must be checked. Already described above are a number of checks that check a country location, if available, against the list of restricted countries. The user's IP address (i.e., the IP address of the device from which the user is making the request for the digital good or license key) is used to determine if the country the user is located in is on a list of restricted countries. In one implementation, a geolocation service is used to provide a country associated with the user's IP address, for example, Ip2location.com of Bradenton, Fla.; MaxMind LLC of Boston, Mass.; and Quova of Mountain View, Calif. As an example, Ip2location.com uses a proprietary IP address look-up database to determine the country associated with an IP address. The IP address is first converted using a mathematical formula into an IP number. The IP number is then compared to beginning and ending IP numbers for each country included in an IP-Country database. Once a match is found, i.e., the IP number falls within the range of IP numbers for a particular country, the country code and country name are thereby identified.

In another implementation, reverse DNS (domain name service) can be used to determine the domain name of the IP address. From the domain name, a country can be ascertained. In either case, the country is not guaranteed to correspond to the country in which the computer with the IP address is located, but is generally reliable.

The country ascertained can be checked against lists of restricted countries, i.e., embargoed and terrorist-supporting countries. If the IP address of the user's computer fails the country check, (“Yes” branch of decision step 210), then the license key is denied (Step 218). If the user's IP address passes the check (“No” branch of decision step 210), then the process 200 moves to a next step.

In the implementation shown, checking the user's IP address is the last check performed; however, it should be understood that the checks described above can be performed in a different order and more or fewer checks can be performed. In any event, once the last check is performed and if all checks have been passed, then, optionally, an export notice can be presented to the user (Step 212). In one implementation, the export notice advises the user that the license key the user is about to download applies to a digital good that is subject to export control laws and regulations. By downloading the license key, the user agrees that they will not knowingly, without prior written authorization from the competent government authorities, export or re-export, either directly or indirectly, any digital good and license key received to a prohibited destination, end-user or end-use. In one implementation, the user may be asked to affirmatively acknowledge the above (e.g., by clicking an “Accept” button) and affirm that the user is not an entity that is prohibited to receive the digital good and is not acting on such an entities behalf and that the final destination of the digital good is not located in any of the restricted countries, which are identified by name (Step 214).

If the user is required to affirmatively accept the terms of the notice, as in the implementation shown, then if the user does accept the terms (“Yes” branch of decision step 214), then the user is granted access to download the license key. Otherwise, if the user does not accept the terms (“No” branch of decision step 214), then the user is denied access to the license key (Step 218).

In some circumstances, one or more checks such as those described above in reference to FIG. 2 may yield a false positive. That is, the result of a check may indicate that access to the license key should be denied, but upon further investigation, it may be determined that in fact the request for the license key should not be denied. To avoid erroneously denying a digital good and/or license key to a licensee based on a false positive, a preliminary export control check can be performed and a false positive resolved before the licensee makes a request for the digital good and/or license key.

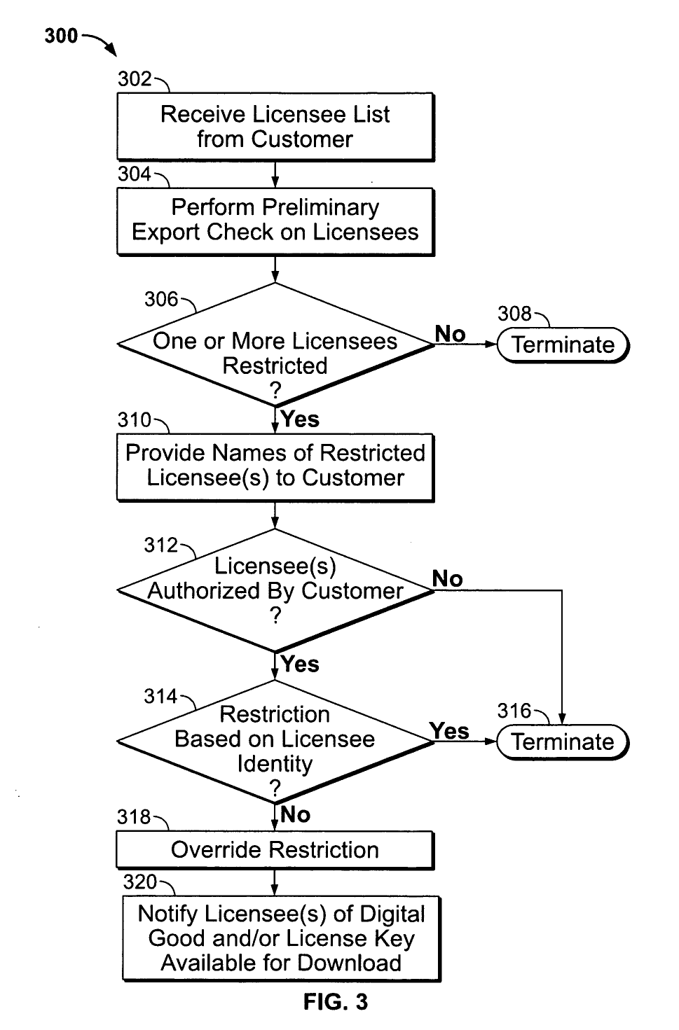

In one implementation, a third party provides the export checks and license key distribution to licensees of a digital good rather than the digital good provider itself. Additionally, the third party may also distribute the digital good itself to the licensee, either with the license key or separately. The third party can perform the preliminary export checks on licensees of the third party's customer, i.e., the digital good provider and licensor. A determination therefore can be made as to whether to override an export restriction for a digital good and/or license key in advance of a licensee requesting the digital good or license key, to avoid unnecessarily denying the licensee access. FIG. 3 is a flowchart showing an example process 300 for performing preliminary export checks and employing overrides on restrictions in certain instances.

The third party receives a licensee list from a customer that identifies the licensees the customer (i.e., the licensor) has authorized to receive access to a digital good and/or license key for the digital good (Step 302). The third party performs a preliminary export check on the licensees (Step 304). That is, the export checks are performed prior to the licensees requesting access to the digital good and/or license key. In one implementation, the export check includes steps 202-210 described above in reference to FIG. 2.

If after performing the preliminary export checks on the licensee list, no licensees are found restricted (“No” branch of decision step 306), then the process can terminate (Step 308). If after performing the preliminary export checks a determination is made that export to one or more of the licensees is restricted (“Yes” branch of decision step 306), then the names of the restricted licensees are provided to the customer (Step 310). The customer can then verify the information upon which the check was performed, or otherwise investigate the basis for the restriction. For example, the fictitious terrorist group “Armed Terrorist Alliance” also referred to by the acronym “ATA” may be included on a list of restricted entities. A teacher working for the fictitious “Australia Teachers Association” also referred to by the acronym “ATA” may fail to pass the preliminary export check, for example, if “ATA” is included in the billing name, and is confused with the restricted entity “Armed Terrorist Alliance”.

The customer can respond to the third party with a list of licensees that were found restricted in the preliminary check, but that should be granted access to the digital good and/or license key. This second list may be a subset of the list of restricted licensees or may be the same, i.e., the customer determines that all preliminary export check restrictions were false positives. In either case, for each name on the list of restricted licensees generated from the preliminary export checks, if the licensee is subsequently authorized by the customer to receive the digital good and/or license key (“Yes” branch of decision step 312), then an override on the restriction may be employed. Referring again to the example above, the customer may confirm that the user's billing name “ATA” in fact stands for “Australia Teachers Association”, rather than the “Armed Terrorist Alliance”.

In one implementation, if the restriction is based on the identity of the licensee (“Yes” branch of decision step 314), then an override is not permitted and the process terminates (Step 316). If the restriction was not based on the identity of the licensee (“No” branch of decision step 314), then an override on the restriction is employed (Step 318) and the licensee can be notified that the digital good and/or license key is available for download (Step 320).

If a licensee named on the list of restricted licensees generated from the preliminary export checks was not subsequently authorized by the customer to receive the digital good and/or license key (“No” branch of decision step 312), then the process terminates (Step 316). The process 300 of performing preliminary checks before notifying a licensee of a digital good or license key being available for download can avoid a customer the embarrassment and inefficiency of notifying a licensee of the availability of a digital good and/or license key and then erroneously denying access to same to the licensee based on a false positive result of an export check.

In one implementation, the process 300 can be automated, with communications between the customer and third party and the third party and the licensees occurring electronically. Thus, from the customer's perspective, once the initial list of licensees is provided to the third party, an automatic process resolves false positives and ensures overrides are employed where appropriate. The steps that occur at the customer end between steps 310 and 312, i.e., the steps the customer takes to determine whether or not the restriction is a false positive, may or may not be automated, depending on the verification steps undertaken by the customer and the technology available. However, in one implementation the steps at the customer end are automated, resulting in a fully automated preliminary check/override process.

The invention and all of the functional operations described in this specification can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. For example, the steps set forth in the flow charts in FIGS. 1-3 can be performed in a different order and still achieve desirable results. Accordingly, other embodiments are within the scope of the following claims.

What is claimed is:

1. A computer-implemented method, comprising:
receiving a request from a user to download a license key, where the license key applies to one or more digital goods, including receiving information related to the user;
identifying which of the one or more digital goods is subject to a most restrictive set of export controls;
performing an export control check based on the identified digital good and the information related to the user; and
if the export control check is passed, then granting access to the license key to the user, or else, if the export check is failed, denying access to the license key to the user.

2. The method of claim 1, wherein receiving a request from a user to download a license key comprises:
verifying an identity of a user;
presenting to the user a list of one or more digital goods licensed to the user; and
receiving from the user a selection of a digital good from the list.

3. The method of claim 1, wherein identifying which of the one or more digital goods is subject to a most restrictive set of export controls comprises:
for each of the one or more digital goods, identifying an export control classification number (ECCN) and if the ECCN is one for which a license exception code is required, then identifying a license exception code; and
identifying which of the one or more digital goods is subject to the most restrictive set of export controls based on their respective ECCN and, if required, license exception code.

4. The method of claim 3, wherein performing an export control check comprises performing one or more checks where the checks performed are adapted to a most restrictive set of export controls of any of the one or more digital goods to which the license key applies.

5. The method of claim 1, further comprising:
verifying an identity of a user, including determining at least one or more of the following about the user: an e-mail address, a billing name and address, a shipping name and address, or the user's name and address; and
wherein, performing an export control check based on the identified digital good and information related to the user comprises performing at least one or more of the following checks:
comparing the user's e-mail address domain to lists of restricted countries;
comparing the user's billing name and address to lists of restricted persons, entities and countries;
comparing the user's shipping name and address to lists of restricted persons, entities and countries; or
comparing the user's name and address to lists of restricted persons, entities and countries.

6. The method of claim 5, wherein:
the one or more checks performed are adapted to a most restrictive set of export controls of any of the one or more digital goods to which the license key applies.

7. The method of claim 6, wherein identifying which of the one or more digital goods is subject to a most restrictive set of export controls comprises:
for each of the one or more digital goods, identifying an export control classification number (ECCN) and if the ECCN is one for which a license exception code is required, then identifying a license exception code; and
identifying which of the one or more digital goods is subject to the most restrictive set of export controls based on their respective ECCN and, if required, license exception code.

8. A computer-implemented method for performing an export control check, comprising:
receiving a request from a user to download a digital good or a license key that applies to a digital good;
performing an export control check based on the digital good and information related to the user, including:
determining a country location of the user using a geolocation service; and
comparing the country location to a list of restricted countries; and
if the export control check is not passed, denying access to the digital good or license key to the user.

9. A computer-implemented method, comprising:
receiving a licensee list from a customer, where each licensee has been licensed a digital good by the customer;
prior to notifying each licensee of the availability of their corresponding licensed digital good or license key for the digital good, performing a preliminary export control check for each licensee based on their licensed digital good and information related to the licensee;
if based on the preliminary export control check, a licensee is found restricted from receiving the licensee's corresponding licensed digital good or license key, then automatically notifying the customer of the restriction and requesting confirmation that the licensee is authorized to receive the digital good; and
if the customer confirms authorization of the licensee to receive the digital good or license key, then instructing an export control check system to override a restriction against export of the licensed digital good or license key to the licensee in a future export control check and notifying the licensee of the availability of the licensed digital good or the license key.

10. The method of claim 9, wherein a licensee has been licensed more than one digital good and wherein performing a preliminary export control check comprises:
identifying which of the digital goods is subject to a most restrictive set of export controls; and
performing the export control check based on the identified digital good and the information related to the user.

11. The method of claim 10, wherein identifying which of the digital goods is subject to a most restrictive set of export controls comprises:
for each of the digital goods, identifying an export control classification number (ECCN) and if the ECCN is one for which a license exception code is required, then identifying a license exception code; and
identifying which of the digital goods is subject to the most restrictive set of export controls based on their respective ECCN and, if required, license exception code.

12. The method of claim 10, wherein performing a preliminary export control check comprises performing one or more checks where the checks performed are adapted to the most restrictive set of export controls.

13. The method of claim 9, wherein:
the licensee list includes at least one or more of the following about the licensee: an e-mail address, a billing name and address, a shipping name and address, or the licensee's name and address; and
performing the preliminary export control check for each licensee based on their licensed digital good and information related to the licensee comprises performing at least one or more of the following checks:
comparing the licensee's e-mail address domain to lists of restricted countries;
comparing the licensee's billing name and address to lists of restricted persons, entities and countries;
comparing the licensee's shipping name and address to lists of restricted persons, entities and countries; or
comparing the licensee's name and address to lists of restricted persons, entities and countries.

14. The method of claim 13, wherein if more than one digital good is licensed to the licensee then the one or more checks performed are adapted to a most restrictive set of export controls of any of the digital goods.

15. The method of claim 14, further comprising identifying which of the digital goods is subject to a most restrictive set of export controls, including:
for each of the digital goods, identifying an export control classification number (ECCN) and if the ECCN is one for which a license exception code is required, then identifying a license exception code; and
identifying which of the digital goods is subject to the most restrictive set of export controls based on their respective ECCN and, if required, license exception code.

16. The method of claim 9, further comprising:
if the licensee was found restricted based on the licensee's identity, then not allowing the export control check system to override the restriction against export of the licensed digital good or license key in a future export control check.

17. A computer program product, encoded on a computer-readable medium, operable to cause data processing apparatus to perform operations comprising:
receiving a request from a user to download a license key, where the license key applies to one or more digital goods, including receiving information related to the user;
identifying which of the one or more digital goods is subject to a most restrictive set of export controls;
performing an export control check based on the identified digital good and the information related to the user; and
if the export control check is passed, then granting access to the license key to the user, or else, if the export check is failed, denying access to the license key to the user.

18. The computer program product of claim 17, wherein receiving a request from a user to download a license key comprises:
verifying an identity of a user;
presenting to the user a list of one or more digital goods licensed to the user; and
receiving from the user a selection of a digital good from the list.

19. The computer program product of claim 17, wherein identifying which of the one or more digital goods is subject to a most restrictive set of export controls comprises:
for each of the one or more digital goods, identifying an export control classification number (ECCN) and if the ECCN is one for which a license exception code is required, then identifying a license exception code; and
identifying which of the one or more digital goods is subject to the most restrictive set of export controls based on their respective ECCN and, if required, license exception code.

20. The computer program product of claim 19, wherein performing an export control check comprises performing one or more checks where the checks performed are adapted to a most restrictive set of export controls of any of the one or more digital goods to which the license key applies.

21. The computer program product of claim 17, operable to cause data processing apparatus to perform operations further comprising:
verifying an identity of a user, including determining at least one or more of the following about the user: an e-mail address, a billing name and address, a shipping name and address, or the user's name and address; and
wherein, performing an export control check based on the identified digital good and information related to the user comprises performing at least one or more of the following checks:
comparing the user's e-mail address domain to lists of restricted countries;
comparing the user's billing name and address to lists of restricted persons, entities and countries;
comparing the user's shipping name and address to lists of restricted persons, entities and countries; or
comparing the user's name and address to lists of restricted persons, entities and countries.

22. The computer program product of claim 21, wherein:
the one or more checks performed are adapted to a most restrictive set of export controls of any of the one or more digital goods to which the license key applies.

23. The computer program product of claim 22, wherein identifying which of the one or more digital goods is subject to a most restrictive set of export controls comprises:
for each of the one or more digital goods, identifying an export control classification number (ECCN) and if the ECCN is one for which a license exception code is required, then identifying a license exception code; and
identifying which of the one or more digital goods is subject to the most restrictive set of export controls based on their respective ECCN and, if required, license exception code.

24. A computer program product, encoded on a computer-readable medium, operable to cause data processing apparatus to perform operations for performing an export control check comprising:
receiving a request from a user to download a digital good or a license key that applies to a digital good;
performing an export control check based on the digital good and information related to the user, including:
determining a country location of the user using a geolocation service; and
comparing the country location to a list of restricted countries; and
if the export control check is not passed, denying access to the digital good or license key to the user.

25. A computer program product, encoded on a computer-readable medium, operable to cause data processing apparatus to perform operations comprising:
receiving a licensee list from a customer, where each licensee has been licensed a digital good by the customer;
prior to notifying each licensee of the availability of their corresponding licensed digital good or license key for the digital good, performing a preliminary export control check for each licensee based on their licensed digital good and information related to the licensee;
if based on the preliminary export control check, a licensee is found restricted from receiving the licensee's corresponding licensed digital good or license key, then automatically notifying the customer of the restriction and requesting confirmation that the licensee is authorized to receive the digital good; and
if the customer confirms authorization of the licensee to receive the digital good or license key, then instructing an export control check system to override a restriction against export of the licensed digital good or license key to the licensee in a future export control check and notifying the licensee of the availability of the licensed digital good or the license key.

26. The computer program product of claim 25, wherein a licensee has been licensed more than one digital good and wherein performing a preliminary export control check comprises:
identifying which of the digital goods is subject to a most restrictive set of export controls; and
performing the export control check based on the identified digital good and the information related to the user.

27. The computer program product of claim 26, wherein identifying which of the digital goods is subject to a most restrictive set of export controls comprises:
for each of the digital goods, identifying an export control classification number (ECCN) and if the ECCN is one for which a license exception code is required, then identifying a license exception code; and
identifying which of the digital goods is subject to the most restrictive set of export controls based on their respective ECCN and, if required, license exception code.

28. The computer program product of claim 26, wherein performing a preliminary export control check comprises performing one or more checks where the checks performed are adapted to the most restrictive set of export controls.

29. The computer program product of claim 25, wherein:
the licensee list includes at least one or more of the following about the licensee: an e-mail address, a billing name and address, a shipping name and address, or the licensee's name and address; and
performing the preliminary export control check for each licensee based on their licensed digital good and information related to the licensee comprises performing at least one or more of the following checks:
comparing the licensee's e-mail address domain to lists of restricted countries;
comparing the licensee's billing name and address to lists of restricted persons, entities and countries;
comparing the licensee's shipping name and address to lists of restricted persons, entities and countries; or
comparing the licensee's name and address to lists of restricted persons, entities and countries.

30. The computer program product of claim 29, wherein if more than one digital good is licensed to the licensee then the one or more checks performed are adapted to a most restrictive set of export controls of any of the digital goods.

31. The computer program product of claim 30, operable to cause data processing apparatus to perform operations further comprising identifying which of the digital goods is subject to a most restrictive set of export controls, including:
for each of the digital goods, identifying an export control classification number (ECCN) and if the ECCN is one for which a license exception code is required, then identifying a license exception code; and
identifying which of the digital goods is subject to the most restrictive set of export controls based on their respective ECCN and, if required, license exception code.

32. The computer program product of claim 25, operable to cause data processing apparatus to perform operations further comprising:
if the licensee was found restricted based on the licensee's identity, then not allowing the export control check system to override the restriction against export of the licensed digital good or license key in a future export control check.

33. A system for performing an export control check, the system comprising:
means for receiving a request from a user to download a license key, where the license key applies to one or more digital goods, including receiving information related to the user;
means for identifying which of the one or more digital goods is subject to a most restrictive set of export controls;
means for performing an export control check based on the identified digital good and the information related to the user; and
means for, if the export control check is passed, then granting access to the license key to the user, or else, if the export check is failed, denying access to the license key to the user.

34. The system of claim 33, wherein means for receiving a request from a user to download a license key comprises:
means for verifying an identity of a user;
means for presenting to the user a list of one or more digital goods licensed to the user; and
means for receiving from the user a selection of a digital good from the list.

35. The system of claim 33, wherein means for identifying which of the one or more digital goods is subject to a most restrictive set of export controls comprises:
means for identifying an export control classification number (ECCN) and if the ECCN is one for which a license exception code is required, then identifying a license exception code, for each of the one or more digital goods; and
means for identifying which of the one or more digital goods is subject to the most restrictive set of export controls based on their respective ECCN and, if required, license exception code.

36. The system of claim 35, wherein means for performing an export control check comprise means for performing one or more checks where the checks performed are adapted to a most restrictive set of export controls of any of the one or more digital goods to which the license key applies.

37. The system of claim 33, further comprising:
means for verifying an identity of a user, including determining at least one or more of the following about the user: an e-mail address, a billing name and address, a shipping name and address, or the user's name and address; and
wherein, means for performing an export control check based on the identified digital good and information related to the user comprise means for performing at least one or more of the following checks:
comparing the user's e-mail address domain to lists of restricted countries;
comparing the user's billing name and address to lists of restricted persons, entities and countries;
comparing the user's shipping name and address to lists of restricted persons, entities and countries; or
comparing the user's name and address to lists of restricted persons, entities and countries.

38. The system of claim 37, wherein:
the one or more checks performed are adapted to a most restrictive set of export controls of any of the one or more digital goods to which the license key applies.

39. The system of claim 38, wherein means for identifying which of the one or more digital goods is subject to a most restrictive set of export controls comprise means for:
for each of the one or more digital goods, identifying an export control classification number (ECCN) and if the ECCN is one for which a license exception code is required, then identifying a license exception code; and
identifying which of the one or more digital goods is subject to the most restrictive set of export controls based on their respective ECCN and, if required, license exception code.

40. A system for performing an export control check, the system comprising:
means for receiving a request from a user to download a digital good or a license key that applies to a digital good;
means for performing an export control check based on the digital good and information related to the user, including:
determining a country location of the user using a geolocation service; and
comparing the country location to a list of restricted countries; and
means for, if the export control check is not passed, denying access to the digital good or license key to the user.

41. A system, comprising:
means for receiving a licensee list from a customer, where each licensee has been licensed a digital good by the customer;
means for prior to notifying each licensee of the availability of their corresponding licensed digital good or license key for the digital good, performing a preliminary export control check for each licensee based on their licensed digital good and information related to the licensee;
means for, if based on the preliminary export control check, a licensee is found restricted from receiving the licensee's corresponding licensed digital good or license key, then automatically notifying the customer of the restriction and requesting confirmation that the licensee is authorized to receive the digital good; and
means for, if the customer confirms authorization of the licensee to receive the digital good or license key, then instructing an export control check system to override a restriction against export of the licensed digital good or license key to the licensee in a future export control check and notifying the licensee of the availability of the licensed digital good or the license key.

42. The system of claim 41, wherein a licensee has been licensed more than one digital good and wherein means for performing a preliminary export control check comprise means for:
identifying which of the digital goods is subject to a most restrictive set of export controls; and
performing the export control check based on the identified digital good and the information related to the user.

43. The system of claim 42, wherein means for identifying which of the digital goods is subject to a most restrictive set of export controls comprise means for:
for each of the digital goods, identifying an export control classification number (ECCN) and if the ECCN is one for which a license exception code is required, then identifying a license exception code; and
identifying which of the digital goods is subject to the most restrictive set of export controls based on their respective ECCN and, if required, license exception code.

44. The system of claim 42, wherein means for performing a preliminary export control check comprise means for performing one or more checks where the checks performed are adapted to the most restrictive set of export controls.

45. The system of claim 41, wherein:
the licensee list includes at least one or more of the following about the licensee: an e-mail address, a billing name and address, a shipping name and address, or the licensee's name and address; and
means for performing the preliminary export control check for each licensee based on their licensed digital good and information related to the licensee comprise means for performing at least one or more of the following checks:
comparing the licensee's e-mail address domain to lists of restricted countries;
comparing the licensee's billing name and address to lists of restricted persons, entities and countries;
comparing the licensee's shipping name and address to lists of restricted persons, entities and countries; or
comparing the licensee's name and address to lists of restricted persons, entities and countries.

46. The system of claim 45, wherein if more than one digital good is licensed to the licensee then the one or more checks performed are adapted to a most restrictive set of export controls of any of the digital goods.

47. The system of claim 46, further comprising means for identifying which of the digital goods is subject to a most restrictive set of export controls, including means for:
for each of the digital goods, identifying an export control classification number (ECCN) and if the ECCN is one for which a license exception code is required, then identifying a license exception code; and
identifying which of the digital goods is subject to the most restrictive set of export controls based on their respective ECCN and, if required, license exception code.

48. The system of claim 41, further comprising:
means for, if the licensee was found restricted based on the licensee's identity, then not allowing the export control check system to override the restriction against export of the licensed digital good or license key in a future export control check.
